(19) United States
(12) Patent Application Publication
(10) Pub. No.: US 2002/0081890 A1
(43) Pub. Date: Jun. 27, 2002

(54) PRINTED CIRCUIT CARD CARRIER FOR LONGITUDINAL ON-LINE REPLACEMENT

(76) Inventor: HANNSJORG OBERMAIER, LOS GATOS, CA (US)

Correspondence Address: HHEWLETT-PACKARD COMPANY, INTELLECTUAL PROPERTY ADMINISTRATION, P.O. BOX 272400, FORT COLLINS, CO, 80527, US

(21) Appl. No.: 09/390,824

(22) Filed: Sep. 7, 1999

(51) Int. Cl. H01R 13/64

(52) U.S. Cl. 439/377

(57) ABSTRACT

A system and method for connecting a laterally installable card longitudinally through an opening in an external wall of a computer system chassis, while the remaining cards of the computer system remain under power and operational. The system includes a carrier with guides and a first system connector for receiving the card. The carrier also includes a related, second system connector configured for longitudinal mating with a system connector on the chassis. The computer system incorporates light pipes that function as guides for the insertion of the carrier into the chassis, where the light pipes can be illuminated to indicate which card is to be changed. A handle provides for the insertion of the carrier into the chassis, and a locking mechanism on the chassis secures the carrier in an installed position.

### BACKGROUND OF THE INVENTION

This invention relates generally to a system for installing printed circuit boards and, more particularly, to an apparatus for connecting, and a method of inserting and extracting, a laterally installable computer system card longitudinally into a multi-card chassis without the disrupting electrical power from the chassis.

Personal computers (PCs), PC servers, UNIX servers, and other computer systems each typically have a chassis that carries a number of cards, which are generally formed from rectangular printed circuit boards configured with electrical components that are directed toward one or more particular functions. Typical cards for a computer system include input/output (I/O) cards, sound cards, video cards, and modem cards. These cards are typically received in female system connectors that are arranged in spaced, parallel relationship on a mother board or other support structure.

Commonly each card's printed circuit board forms a male system connecter that conforms to the female system connectors, configuring the card for connection to the computer system. The male and female connectors are typically in a particular format that is a standard for the type of electronic connections being made. For example, PCs commonly are configured with system connectors in the Industry Standard Architecture (ISA), Extended Industry Standard Architecture (EISA) and/or Peripheral Component Interconnect (PCI) formats. Each of these formats conforms to standards for the respective types of bus and/or connection that is being used by the computer system.

Many types of computer system cards are configured with a bulkhead that carries some type of external connector for the computer system. Common types of external connectors include parallel ports, serial ports, monitor ports, phone jacks, audio ports and midi ports. When such cards are installed in the computer, the computers are configured such that the bulkheads are externally accessible, providing for the external connectors to be used without opening the chassis.

For many types of computer system cards, the system connector is located on a lower edge, and the bulkheads of the cards are located on a side of a card that adjoins the lower edge. Thus, the bulkhead is oriented parallel to the direction of the card's insertion and extraction, and orthogonal to the edge having the system connector. Typical ISA, EISA and PCI cards are configured this way. Often, such cards are individual in their heights and widths (e.g., the distance between the opposing edges of one PCI card can differ from the respective distances on another PCI card).

The typical installation procedure for such a card involves powering down the computer, opening up the chassis, and inserting the card's male system connector into the computer system's female connector. At the end of this procedure, the bulkhead typically adjoins an internal surface of an external wall of the chassis, where the external wall has an opening configured to expose the bulkhead's external connectors. Normally, the card is held in place by the system connector, and by a screw that secures the bulkhead to the chassis.

Occasionly, cards must be inserted and/or removed, either to change the computer system's configuration or to remedy a faulty card. In many instances, more than just a single card must be removed and inserted, because consecutive cards are closely spaced, and can render a smaller card inaccessible. This has proven to be lengthy and disruptive, and it has given rise to the need for a means to insert and/or remove cards without having to open the chassis and/or shut down electrical power to the remainder of the system.

The insertion and/or removal of cards from a system without disrupting the operation of a system is commonly referred to as On-Line Replacement (OLR). It is known for cards to be configured with a bulkhead and a system connector on opposing sides to enable OLR. Typically, the side of the card that forms the system connector is inserted into an opening in the chassis, while the person inserting the card holds the card by its bulkhead, and most commonly, by a handle on its bulkhead. The other two sides of the card, which extend between the sides having the system connector and bulkhead, are received in tracks that guide the card's system connector to female system connector on the chassis.

A fully capable system configured for OLR includes OLR hardware, system software and OS support, device drivers, and a user interface. The hardware and software function together to ensure that any OLR activity is benign to other devices connected to the computer bus. Typically, the OLR hardware isolates the logic and power signals of a single printed circuit card slot from all other devices connected to the computer bus. A digital OLR controller arbitrates for the computer bus and controls all of the logic signals for each slot. Power control electronics allows for power sequencing on the computer bus, ensuring that power to the card slot is switched off for OLR, while stable power continues to be delivered to other devices on the computer bus.

OLR solutions have been provided in the past by systems compatible with printed circuit card industry standards, including VME or Compact-PCI cards, which are of one or two fixed sizes. In these systems, the cards are configured to be supported by card guides such that they can be removed and installed without contacting neighboring cards. Typically, the bulkheads of such cards are oriented orthogonal to the direction of extraction, on an edge that is opposite of, and parallel to, the edges having the system connector. The typical force required to insert some cards into a system connector can be as high as 60 pounds (or higher). Such bulkheads are known to incorporate handles and latches for convenient handling and replacement.

The above-described solutions do not provide for OLR of variable size cards conforming to the common industry formats having a bulkhead configured parallel to the insertion direction, such as ISA, EISA and PCI cards. Furthermore, the bulkhead of such cards do not provide handles or other detail for facilitating insertion or removal.

Some OLR systems have been devised for use with PCI cards, such as placing the PCI card within a cage (or drawer), typically requiring extended connectors and interfering with cooling airflow. One such system incorporates special adapters and handles, while another incorporates special dividers and guides, along with handles, for accommodating size variations and obviating potential electrical shorting of adjacent cards. These known OLR systems for use with PCI cards use standard system connectors, and maintain a standard extraction procedure parallel with the bulkhead. Similar to the cases described above, this generally requires a removal of covers and/or drawers to open the chassis and gain access to the card.

Accordingly, there has existed a need for an improved OLR system for use with PCI cards and the like, and a related method of inserting cards for OLR, that provides for safe and convenient insertion and/or removal of the cards, without requiring a shutdown of electrical power to any other cards. The present invention satisfies these and other needs, and provides further related advantages.

### SUMMARY OF THE INVENTION

The present invention provides an improved OLR system for use with computer system cards having bulkheads parallel to the cards' insertion direction, and with a related method of inserting cards for on-line replacement. The system and method can provide for safe and convenient insertion, replacement and removal of the cards, without requiring a shutdown of electrical power to any other cards.

The invention includes a computer system configured to be connected to one or more printed circuit board cards. Each of these cards has a lower edge that forms a system connector defining a card-insertion direction. Each card also has a bulkhead that is substantially parallel to the insertion-direction defined by the card's system connector.

The computer system includes a chassis having one or more openings that lead to an interior portion of the chassis. These openings are configured for receiving the one or more of the cards. A central processing unit of the computer system connects to a bus, which connects to one or more chassis system connectors mounted in the interior portion of the chassis. The chassis system connectors define a chassis-insertion direction with the chassis' one or more openings.

The invention features one or more carriers for connecting the cards to the computer system. Each carrier has a body having a front end and a rear end, a first system connector configured to mate with the card's system connector in the card-insertion direction, and a second system connector configured to mate with the chassis' system connector. Each carrier's first and second system connector are in communication with each other so as to put a card in communication with the computer system. The use of the carriers can advantageously allow the cards' bulkheads to be approximately coplanar with the chassis' opening(s) when each card's system connector is in communication with the computer system.

The system further features tracks configured to guide carriers through the chassis openings, and to guide the second system connectors of the guided carriers to mate with chassis' system connectors. The tracks extend from an end within the chassis to an end at the chassis' opening. The tracks are composed of a translucent material, and a light source at the tracks end within the chassis serves to illuminate the track's end at the chassis opening, and thereby provide information on the status of the card. This feature advantageously provides an efficient communication system from an internal portion of the chassis to the opening where a card is inserted.

Other features and advantages of the invention will become apparent from the following detailed description of the preferred embodiment, taken in conjunction with the accompanying drawings, which illustrate, by way of example, the principles of the invention.

### BRIEF DESCRIPTION OF THE DRAWINGS

FIG. 1 is a perspective view of an embodiment of a computer system including an on-line replacement (OLR) apparatus in accordance with the invention, shown in its uninstalled position, with a printed circuit positioned to be installed in the apparatus.

FIG. 2 is a perspective view the embodiment depicted in FIG. 1 shown in its installed position.

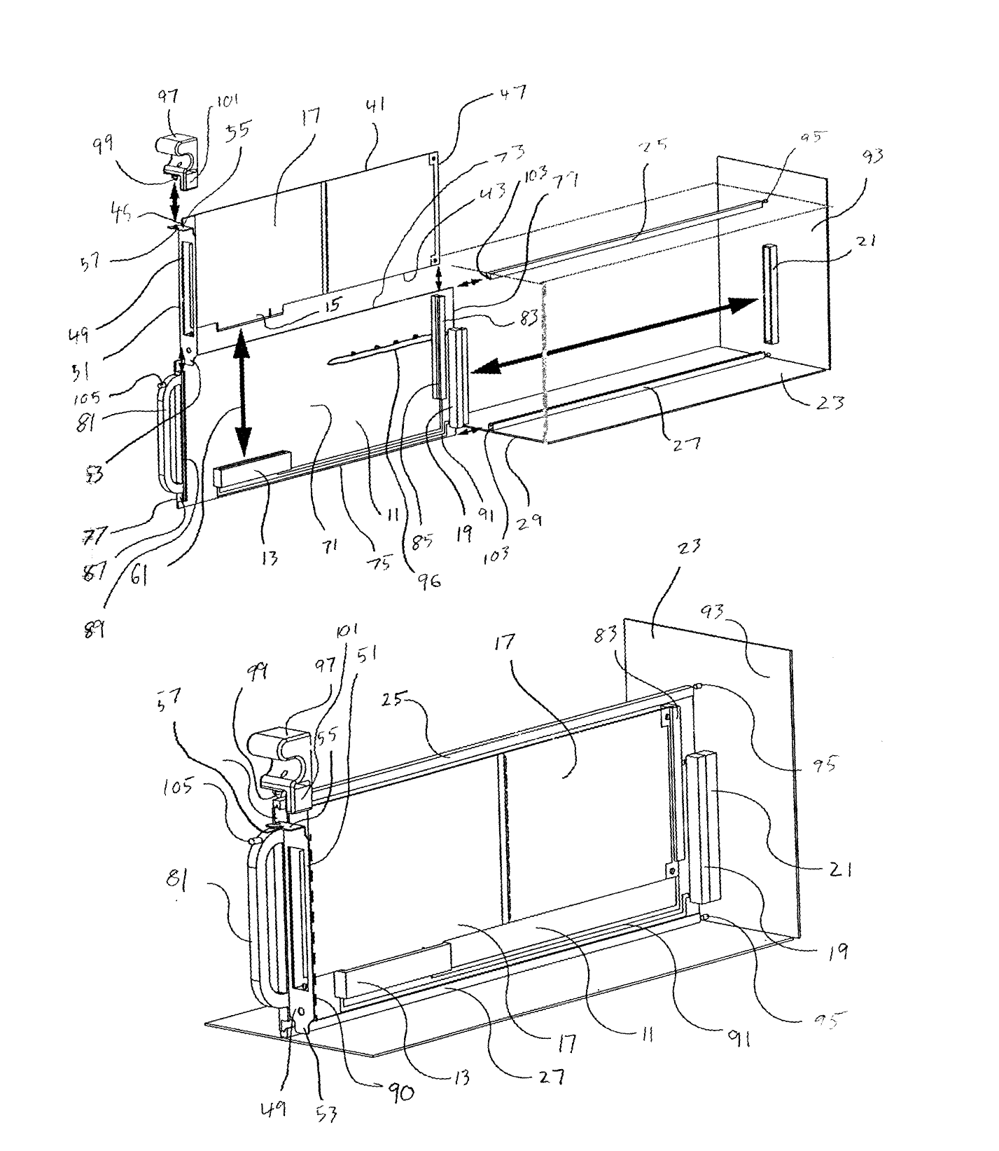

### DESCRIPTION OF THE PREFERRED EMBODIMENT

With reference now to the illustrative drawings, there is shown a system for connecting, and a carrier 11 and related method according to the invention, for inserting and extracting, a laterally installable computer system PCI card 17 longitudinally into a multi-card chassis 23, without the disrupting electrical power from the chassis. The carrier 11 has a first, preferably female, system connector 13 configured to mate with a laterally installable, preferably male, system connector 15 on the PCI card 17, and it further has a second, preferably male, system connector 19 configured to mate with a longitudinally installable, preferably female, system connector 21 on the chassis.

The terms lateral and longitudinal are to be understood as referring to a card direction with respect to the bulkhead. Thus, the term “lateral” is a reference to the side to side dimension when a card is held, by the bulkhead, with the card extending away from the holder. The terms are not a reference to relative dimensions of the card (i.e., it does not matter if the card is longer than wide or vice versa).

Preferably, the system includes the above apparatus, along with connecting features such as an upper light pipe 25 and a lower light pipe 27. The light pipes are preferably mounted on the chassis 23 and configured as tracks that can guide the carrier longitudinally through an opening 29 defined in the chassis, and guide the carrier's second system connector 19 to longitudinally mate with the chassis' system connector 21. The system also preferably includes typical subsystems (not shown) to provide for on-line replacement (OLR) of cards. Such subsystems can include OLR hardware, system software and OS support, device drivers, and a user interface. These subsystems are designed to ensure that any OLR activity is benign to other devices connected to the computer.

The PCI card 17 is of a conventional layout, being configured to be installed by lowering its male system connector 15 into a mating female connector and then fastening it to an adjacent exterior chassis wall. This procedure has not been entirely satisfactory, because it generally has required a removal of covers and/or drawers to gain access.

In particular, the card has an upper edge 41, a lower edge 43, a forward edge 45 and a rearward edge 47. However, the height of the card (i.e., the lateral distance between the upper and lower edges at some given longitudinal location) and the length of the card (i.e., the longitudinal distance between the forward and rearward edges at some given lateral location) are not restricted, except perhaps by the size maximum restrictions of standard cards of this type. The above use or the terms upper and lower is to be understood as a reference to the configuration of cards inserted into a desktop PC, and thus the upper and lower edges are on laterally opposite sides of the card. Likewise, the forward and rearward edges are on longitudinally opposite sides of the card.

The forward edge 45 of the PCI card 17 incorporates a bulkhead 49, which has a main surface 51 that can adjoin or mount connectors for external devices (not shown). For mating with a conventional personal computer (PC), the bulkhead includes a lower tab 53 that is coplanar with the main surface, and an upper tab 55 that extends in a direction normal to the forward edge of the card. The upper tab defines a screw hole 57 for affixing the card to a conventional PC chassis, thus securing and grounding the card.

The lower edge 43 of the card 17 defines a conventional PCI multi-pin system connector 15 that is configured for insertion and removal in a lateral card-insertion direction 61. This lateral card-insertion direction is substantially parallel to the forward edge 45 of the card, and to the principal dimension of the bulkhead (between the lower and upper tabs, 53 and 55, respectively). In order to conform to conventional PC systems, the card's system connector is a standardized distance form the forward edge of the card. In the context of this application, it is to be understood that the direction defined by a connector for insertion and removal is the natural insertion direction for a male-female connector.

The carrier 11 is configured to receive, structurally support, and electrically connect to the PCI card. The carrier preferably includes a body 71 having an upper edge 73, a lower edge 75, a front end 77 and a back end 79, and further includes a handle 81 along the front end, configured for controlling the longitudinal insertion and extraction of the carrier into and out of the chassis. The first and second system connectors 13, 19 are preferably configured to accommodate both 32-bit and 64-bit cards, and the system connectors are rated for 5 volt and 3.3 volt applications.

The carrier 11 preferably includes one or more guides that are configured to guide the card 17 into place on the carrier and/or to provide structural support to the card. In particular, the carrier includes a rear guide 83 forming a rear track 85 that faces in a longitudinal direction and is configured to slidingly receive the rearward edge 79 of the card, a front guide 87 forming a front track 89 facing in a direction to slidingly receive a side of the main surface 51 of the card's bulkhead 49, as well as the carrier's first system connector 13. Each of these three features slidably receive the card in a lateral direction to mate with the carrier. The rear track is slidably adjustable along a slot 96 to accommodate for cards of different lengths. A spring-biased pin (not shown) locks the rear track into place, preferably at standard card lengths.

The carrier 11 also includes a card-lock 97 that is laterally slid downward over the bulkhead 49 to lock the card 17 into the carrier. In particular, the lock includes a pin 99 configured to mate with the screw hole 57 in the bulkhead, and a flange 101 that is configured to structurally retain the side of the bulkhead. The carrier 11 further includes a chassis-lock 105 button that is configured to operate a lock that will lock the carrier into the chassis.

Wiring 91 electrically connects the carrier's first system connector 13 with its second system connector 19. The wiring is preferably integral with the carrier, but could be separately carried by it. Preferably, the carrier's two system connectors are in the same format, and most preferably the two system connectors have a one-to-one relationship between their respective electrical connections.

The chassis' system connector 21 is preferably mounted on a computer I/O backplane 93 that carries several other (preferably PCI) system connectors (not shown), each in a spaced, parallel relationship to each other, and each being preferably configured to mate with a printed circuit card carrier similar to the one described above.

The upper and lower light pipes 25, 27 are connected to the computer chassis 23, and are preferably configured as tracks that longitudinally receive and guide the upper edge 73 and lower edge 75 of the carrier 11 through the chassis' opening 29 in a chassis-insertion direction 63 so as to guide the carrier's second system connector 19 to mate with the chassis' system connector 21. The chassis' opening and system connector thus define the chassis-insertion direction. To aid in the insertion of the carrier, the opening (or openings) defined in the chassis are aligned with one or more corresponding upper and lower light pipes, and with one or more chassis system connectors on the I/O backplane 93. Light emitting diodes (LEDs) 95 connected to the backplane are used to illuminate the light pipes.

When the card 17 is fully inserted and locked into the carrier 11, and when the carrier is fully inserted into the chassis 23, the main surface 51 of the card's bulkhead 49 is approximately coplanar and flush with an external wall (not shown) of the chassis, providing for exterior access to the bulkhead. At the same time, the light pipes 25, 27 retain the carrier and card so as to avoid their coming into contact with other carriers and cards that are inserted into the chassis in other chassis system connectors. Preferably, either the chassis or the carrier includes a compressive, electrically conductive material 90, configured to create an electrical connection between the chassis and the card when the carrier is inserted in the chassis. Preferably, the compressive, electrically conductive material makes the contact in the vicinity of the opening 29, and preferably it prevents the leakage of electromagnetic energy.

The system of this embodiment is preferably configured for OLR, and preferably includes an OLR subsystem, including the appropriate OLR hardware, system software, operating system support, device drivers, and a user interface, to conduct OLR without electronically interfering with the operation of the other cards. In particular, the hardware and software function together to ensure that any OLR activity is benign to other devices connected to the computer bus, which in turn connects to the computers one or more central processing units. Typically, for replacement of the card 17, the OLR hardware isolates the logic and power signals to the chassis' system connector 21 from the signals of all other devices connected to the relevant computer bus. A digital OLR controller arbitrates for the computer bus and controls all of the logic signals for each slot. Power control electronics allows for power sequencing on the computer bus, ensuring that power to the chassis' system connector 21 is switched off during OLR, while stable power continues to be delivered to other devices connected to the computer bus. Typically, the central processing unit, bus, and OLR subsystem will be contained within the chassis 23.

If a user becomes aware that the PCI card 17 ever becomes faulty, if system tests ever show that the PCI card has become faulty, or even if the user simply elects to replace a given card, then either the user or the system indicates that the card should be changed to the OLR system hardware or software. The OLR system then preferably illuminates the light-emitting diodes 95, which are aligned with the upper and lower light pipes 25, 27, thereby illuminating visible ends 103 of the light pipes. The user can thus identify which card is to be removed by noting the illuminated ends of the light pipes. The light pipes can be further used to indicate the power status of a card, and whether the correct card has been inserted.

The carrier 11 is removed from the chassis 23 by disengaging the lock 97 through use of a release button 105, grasping the handle 81, and extracting the carrier longitudinally from the chassis. The card 17 is then removed from the carrier by sliding the card along the front and rear guides 83 and 87, respectively, to disengage the card's system connector 15 from the carrier's first system connector 13. A new card can be inserted into the chassis by reversing the order of the steps of extraction.

It should be appreciated from the foregoing description that the present invention provides an improved apparatus, system and related method for removing and installing, and thereby connecting laterally installable cards longitudinally through a side wall of a computer system, while the remaining cards of the computer system remain under power and operational.

While a particular form of the invention has been illustrated and described, it will be apparent that various modifications can be made without departing from the spirit and scope of the invention. Thus, although the invention has been described in detail with reference only to the preferred embodiment, those having ordinary skill in the art will appreciate that various modifications can be made without departing from the invention. Accordingly, the invention is not intended to be limited, and is defined with reference to the following claims.

I claim:

1. A carrier for connecting a printed circuit board card to a chassis, wherein the card has a lower edge including a system connector that defines a card-insertion direction, and a bulkhead that is oriented substantially parallel to the insertion direction defined by the card's system connector, wherein the chassis defines an opening for receiving a card, and wherein the chassis includes a system connector to be placed in communication with the system connector of the received card, the chassis' system connector and opening defining a chassis-insertion direction, comprising:
a body having a front end and a rear end;
a first system connector carried on the body and configured to mate with the card's system connector in the card-insertion direction, and
a second system connector carried on the body and configured to mate with the chassis' system connector, wherein the second system connector is in communication with the first system connector;
wherein the carrier's body and first system connector are configured such that the carrier's second system connector can be inserted into the opening in the chassis-insertion direction to mate with the chassis' system connector while the card's system connector is mated to the carrier's first system connector.

2. The carrier of claim 1, wherein the carrier's body and first system connector are configured such that the card's bulkhead would be approximately coplanar with the chassis' opening when the card's system connector is mated with the carrier's first system connector and the carrier's second system connector is mated with the chassis' system connector.

3. The carrier of claim 2, wherein the body includes integral wiring to put the carrier's second system connector in communication with the carrier's first system connector.

4. The carrier of claim 2, and further including a guide at the front end of the body, the guide being configured to guide the card movement in mating the card's system connector with the carrier's first system connector, and the guide being configured to support the card when the card's system connector is mated with the carrier's first system connector.

5. The carrier of claim 2, and further including:
a guide at the front end of the body, the guide being configured to guide the card movement in mating the card's system connector with the carrier's first system connector, and the guide being configured to support the card when the card's system connector is mated with the carrier's first system connector; and
a handle integral with the guide, the handle being configured for controlling the insertion and extraction of the carrier into and out of the chassis.

6. The carrier of claim 2, and further including a first guide at the front end of the body and a second guide at the back end of the body, the first and second guides being configured to guide the card movement in mating the card's system connector with the carrier's first system connector, the first and second guides being configured to support the card when the card's system connector is mated with the carrier's first system connector, and the second guide being adjustable to accommodate different length cards.

7. The carrier of claim 2, wherein the carrier's first system connector is configured for the card to be a PCI card.

8. A connection system for connecting a printed circuit board card to a chassis, wherein the card has a lower edge including a system connector that defines a card-insertion direction, and a bulkhead that is substantially parallel to the insertion direction defined by the card's system connector, and wherein the chassis defines an opening for receiving a card, comprising:
a chassis system connector mounted in the interior of the chassis, the chassis' system connector and opening defining a chassis-insertion direction; and
a carrier, the carrier comprising
a body having a front end and a rear end,
a first system connector carried on the body, the first system connector being configured to mate with the card's system connector in the card-insertion direction, and
a second system connector carried on the body, configured to mate with the chassis' system connector, the second system connector being in communication with the first system connector;
wherein the carrier's body and first system connector are configured such that the carrier' second system connector can be inserted into the opening in the chassis-insertion direction to mate with the chassis' system connector while the card's system connector is mated to the carrier's first system connector; and
wherein the carrier's body and first system connector are configured such that the card's bulkhead would be approximately coplanar with the chassis' opening when the card's system connector is mated with the carrier's first system connector and the carrier's second system connector is mated with the chassis' system connector.

9. The connection system of claim 8, and further comprising a guide configured to guide the carrier through the chassis' opening, and configured to guide the carrier's second system connector to mate with the chassis' system connector.

10. The connection system of claim 8, and further comprising:
a guide extending from an end within the chassis to an end at the chassis' opening, the guide being configured to guide the carrier through the chassis' opening, and configured to guide the carrier's second system connector to mate with the chassis' system connector, wherein the guide is configured as a track composed of a translucent material; and
a light source at the guide's end within the chassis, the light source being configured to illuminate the guide's end at the chassis opening, and the light source being configured to provide information on the status of the card.

11. The connection system of claim 8, and further comprising a compressive, electrically conductive material configured to contact both the card and the chassis when the carrier and card are inserted in the chassis, to create an electrical connection between the chassis and the card.

12. The connection system of claim 8, and further comprising:
a guide extending from an end within the chassis to an end at the chassis' opening, the guide being configured to guide the carrier through the chassis' opening, and configured to guide the carrier's second system connector to mate with the chassis' system connector, wherein the guide is configured as a track composed of a translucent material;
a light source at the guide's end within the chassis, the light source being configured to illuminate the guide's end at the chassis opening, and the light source being configured to provide information on the status of the card; and
a compressive, electrically conductive material configured to contact both the card and the chassis when the carrier and card are inserted in the chassis, to create an electrical connection between the chassis and the card;
wherein the carrier's first system connector is configured for the card to be a PCI card.

13. A computer system configured to be connected to a plurality of printed circuit board cards, wherein each card has a lower edge including a system connector that defines a card-insertion direction, and each card has a bulkhead that is substantially parallel to the insertion direction defined by the card's system connector, comprising:
a chassis defining an interior and one or more openings into the interior for receiving the plurality of cards;
a central processing unit;
a bus connecting to the central processing unit;
a plurality of chassis system connectors mounted in the interior of the chassis and connected to the bus, each of the plurality of chassis system connectors defining a chassis-insertion direction with one of the one or more openings;
a plurality of carriers, each carrier comprising
a body having a front end and a rear end,
a first system connector carried on the body, the first system connector being configured to mate with the card's system connector in the card-insertion direction, and
a second system connector carried on the body, configured to mate with the chassis' system connector, the second system connector being in communication with the first system connector; and
a plurality of guides, each guide being configured to guide at least one of the plurality of carriers through one of the one or more chassis openings, and further guide the second system connector of the guided carriers to mate with one of the chassis' system connectors;
wherein each carrier's body and first system connector are configured such that the carrier's second system connector can be inserted into an at least one opening in the chassis-insertion direction to mate with a chassis' system connector while one of the plurality of cards' system connectors is mated to the carrier's first system connector; and
wherein each carrier's body and first system connector are configured such that a card's bulkhead would be approximately coplanar with a chassis opening when the card's system connector is mated with the carrier's first system connector and the carrier's second system connector is mated with a chassis' system connector.

14. The computer system of claim 13, and further comprising a subsystem configured to isolate logic and power signals between one of the plurality of chassis system connectors and the rest of the plurality of chassis system connectors.

15. The computer system of claim 13, wherein:
each of the plurality of guides extend from an end within the chassis to an end at one of the one or more openings of the chassis, the guide being configured as a track composed of a translucent material;
the computer system further comprises a light source at the each of the plurality of guide's ends within the chassis, the light source being configured to illuminate the guides' ends at the chassis opening, and the light source being configured to provide information on the status of a card received along that guide; and
the computer system further comprises a subsystem configured to isolate logic and power signals between one of the plurality of chassis system connectors and the rest of the plurality of chassis system connectors, and configured to activate the light sources to provide the information on the status of the card.

16. A connection system for connecting a system connector in communication with a printed circuit board card to a circuit board backplane within the interior of a chassis that defines an opening for receiving the card, comprising:
a chassis system connector configured for mounting on the backplane, the chassis system connector defining a chassis-insertion direction with the opening;
a guide being configured as a track to guide the card through the chassis opening, and further guide the system connector in communication with the card to mate with the chassis system connector, wherein the guide extends from an end adjacent to the backplane to an end at the opening of the chassis, the guide being composed of a translucent material;
a light source on the backplane at the guide's end within the chassis, the light source being configured to illuminate the guide's ends at the chassis opening, and the light source being configured to provide information on the status of the card received along the guide; and
a subsystem configured to activate the light source to provide the information on the status of the card.

17. A method of connecting a printed circuit board cards to a computer, wherein the card has a lower edge including a system connector that defines a card-insertion direction, wherein the card has a bulkhead that is substantially parallel to the insertion direction defined by the card's system connector, wherein the computer has a chassis defining an interior and an opening into the interior for receiving the card, and wherein the computer has a chassis system connector mounted in the interior of the chassis, the chassis system connector defining a chassis-insertion direction with the opening, comprising:
mating the card's system connector with a system connector on a carrier, wherein the carrier includes:
a body having a front end and a rear end,
a first system connector carried on the body, the first system connector being configured to mate with the card's system connector in the card-insertion direction, and
a second system connector carried on the body, configured to mate with the chassis' system connector, the second system connector being in communication with the first system connector;
guiding the carrier through the chassis opening in the chassis-insertion direction; and
mating the carrier's second system connector with the chassis' system connector;
wherein the carrier's body and first system connector are configured such that the card's bulkhead is approximately coplanar with the chassis opening after the card's system connector is mated with the carrier's first system connector and after the carrier's second system connector is mated with a chassis' system connector.

18. The method of claim 17, wherein the step of guiding comprises guiding the carrier with a guide configured to guide the carrier through the chassis opening, and configured to guide the second system connector of the carrier to mate with the chassis' system connector.

19. The method of claim 17, and further comprising isolating logic and power signals to the chassis' system connector prior to mating the carrier's second system connector with the chassis' system connector.

20. A connection system for connecting a printed circuit board card to a chassis, wherein the card has a lower edge including a system connector that defines a card-insertion direction, and a bulkhead that is substantially parallel to the insertion direction defined by the card's system connector, and wherein the chassis defines an opening for receiving a card, comprising:
a chassis system connector mounted in the interior of the chassis, the chassis' system connector and opening defining a chassis-insertion direction; and
a means for placing the card's system connector in communication with the chassis' system connector, wherein the card's bulkhead is positioned to be approximately coplanar with the chassis opening when the card's system connector in communication with the chassis' system connector;
wherein the chassis system connector is not substantially parallel to the card's system connector.
